(19) United States
(12) Patent Application Publication
(10) Pub. No.: US 2014/0117978 A1
(43) Pub. Date: May 1, 2014

(54) ENCODER ELEMENT AND METHOD FOR THE MANUFACTURE THEREOF

(71) Applicants: Paul HUND, Schwieberdingen (DE); Lars BOMMER, Leonberg (DE); Helmut SCHNEIDER, Aichtal (DE); Nikolaus HAUTMANN, Ditzingen (DE); Ralf DIEKMANN, Schwieberdingen (DE); Nadja WOLFANGEL, Stuttgart (DE)

(72) Inventors: Paul HUND, Schwieberdingen (DE); Lars BOMMER, Leonberg (DE); Helmut SCHNEIDER, Aichtal (DE); Nikolaus HAUTMANN, Ditzingen (DE); Ralf DIEKMANN, Schwieberdingen (DE); Nadja WOLFANGEL, Stuttgart (DE)

(73) Assignee: ROBERT BOSCH GMBH, Stuttgart (DE)

(21) Appl. No.: 14/068,177

(22) Filed: Oct. 31, 2013

(30) Foreign Application Priority Data
Oct. 31, 2012 (DE) 10 2012 219 890.3

(51) Int. Cl. G01D 5/12

(52) U.S. Cl. CPC G01D 5/12
USPC 324/207.11; 427/130; 427/554; 216/22; 427/569

(57) ABSTRACT

A method is described for manufacturing an encoder element having a base body and a magnetic layer situated on the outer circumference of the base body, including the following steps: providing the base body; providing a magnetic or magnetizable powdery material; directly applying the powdery material to the outer circumference or to an end face of the base body to generate the magnetic layer in such a way that an integral, direct joint is created between the base body and the magnetic layer; and magnetizing the applied magnetic layer.

### FIELD OF THE INVENTION

The present invention relates to a method for manufacturing an encoder element and to such an encoder element having magnetic properties.

### BACKGROUND INFORMATION

Magnetic encoder wheels are used, for example, in the field of the automotive industry in a variety of ways as part of ABS systems, on camshafts, on crankshafts and on steering systems. To manufacture such encoder wheels, a rubber material mixed with magnetic filler material is usually vulcanized onto a metal wheel. Such encoder wheels have been successfully employed in particular in the field of automotive engineering, where high alternating stresses due to changing temperatures and, in the winter for example, contact with salty water and the like are possible. However, drawbacks of the rubber magnet element applied by vulcanization are that this results in relatively high costs and additionally may only be applied in a certain minimum thickness due to the vulcanization process. Moreover, an encoder wheel is known from German Published Patent Application No. 102005022451, in which an adhesive layer made of an acrylic adhesive is provided between a supporting structural component and an encoder element. However, this known method is also very complex and must be carried out with maximum manufacturing precision, which in practice results in high reject rates during production. It would therefore be desirable to have a method for manufacturing an encoder element which is able to be carried out as cost-effectively as possible and to satisfy the necessary requirements, in particular in applications in automotive engineering.

### SUMMARY

The method according to the present invention for manufacturing an encoder element has the advantage over the related art that the method may be carried out very quickly and cost-effectively. In addition, a joint between a base body and a magnetic layer is obtained, which is absolutely tight. This eliminates the risk that water or other liquids may penetrate into the region between the base body and the magnetic layer. In addition, according to the present invention the use of rubber or synthetic rubber or the like may be dispensed with. After the step of applying the magnetic layer to the base body, no further post-processing is required, and the method according to the present invention allows easy and controlled automation, with maximum precision of the manufactured structural component. This is achieved according to the present invention in that a base body and a magnetic or magnetizable, powdery material are provided in the method according to the present invention. The magnetic or magnetizable, powdery material is then applied to the base body by direct spraying onto the outer circumference and/or onto an end face of the base body. In this way, a magnetic layer is generated on the base body in such a way that an integral, direct joint is created between the base body and the magnetic layer. According to the present invention, the number of manufacturing steps may thus be significantly reduced for such encoder wheels. This results in major cost and time advantages. In addition, a particularly tight joint may be achieved between the magnetic layer and the base body, so that in particular salt water or the like is not able to penetrate between the magnetic layer and the base body. According to the present invention, it is further achieved that no post-processing steps are necessary, but an encoder wheel thus manufactured may be used immediately. Compared to the vulcanized magnetic layers made of rubber, the concentricity properties and imbalances are also considerably lower with the encoder wheel according to the present invention. In addition, according to the present invention a minimum layer width and minimum thickness of the magnetic layer may be generated. In a last step, the applied magnetic layer is subsequently magnetized to provide a customary multipole arrangement of the encoder element.

The powdery material is preferably applied to the base body without tools with the aid of a jet. In this way, in particular forming tools, such as injection molding tools or the like, may be dispensed with. By controlling the jet for applying the powdery material, the layer width and layer thickness may be exactly determined. Forming tools are therefore no longer required. In this way, in particular also the tooling costs may be drastically reduced, for example when the production is changed over to a different encoder wheel, e.g., for a different customer. The flexibility during production may thus also be significantly improved.

To improve the adhesiveness of the sprayed-on spray granules, prior to the step of applying the powdery material, nanostructures are generated on the surface in regions of the base body in which the powdery material is to be applied. The nanostructures are preferably irregular structures, in particular cauliflower-like structures. As an alternative, the nanostructures are regular structures, in particular lines.

The nanostructures are particularly preferably created with the aid of an ultrashort pulse laser. As an alternative, the nanostructures are created with the aid of an etching method.

It is further preferred if the magnetic layer has a thickness of less than 1 mm, and in particular a thickness of less than 0.8 mm. In this way, the encoder element according to the present invention may also be used in confined installation spaces.

It is particularly preferred if the powdery material has a particle size of smaller than or equal to 40 μm. According to the present invention, the particle size is defined in such a way that a maximum length of a straight line that may be placed through a particle is always smaller than or equal to 40 μm.

It is further preferred if the powdery material is applied by a cold gas spraying method with the aid of a jet. Particularly good homogeneous distribution of the magnetic particles may thus be achieved. The cold gas spraying method is preferably carried out with the aid of a nitrogen gas or helium gas, or mixtures of these two gases.

As an alternative, the powdery material is applied by a cold active plasma jet with the aid of a jet. The plasma jet is preferably provided at ambient pressure and sprayed onto the surface of the base body together with the added powdery material, whereby the base body heats up to not more than 100° C. Warping or another temperature-induced change in the form of the base body may be avoided in particular due to the relatively low temperatures. This method may also be carried out without the use of injection molding tools.

It is further preferred if the powdery material used is pure magnetic powder or, alternatively, a magnetic powder in which the individual magnetic particles are sheathed with a plastic material. Use of the magnetic particles sheathed with plastic material results in the advantage that, simultaneously with the spraying process, an anti-corrosion layer is obtained due to the plastic material accumulating on the outer surface of the magnetic layer.

It is further preferred if another step of applying an additional anti-corrosion layer is carried out after the magnetic layer has been applied. In this way, in particular the service life of the encoder element according to the present invention is improved.

It is particularly preferred if the base body is a metal, and in particular a sheet metal. It is further preferred if the base body is essentially circular. The present invention further relates to an encoder element, in particular an encoder wheel, which includes a base body, in particular a circular metal body, and a sprayed-on magnetic layer. A direct, integral joint is thus formed between the base body and the plastic element.

The encoder element according to the present invention preferably has nanostructures on the base body in a region in which the magnetic layer is applied. The nanostructures may have regular or irregular forms.

The encoder elements according to the present invention may be used in particular in automotive engineering, e.g., on shafts or bearings, in conjunction with rotary and position sensors and the like. Use in machines and tools, in particular handheld power tools, is likewise conceivable.

### BRIEF DESCRIPTION OF THE DRAWINGS

FIGS. 1 through 4 show schematic views which illustrate the steps for manufacturing an encoder element.

### DETAILED DESCRIPTION

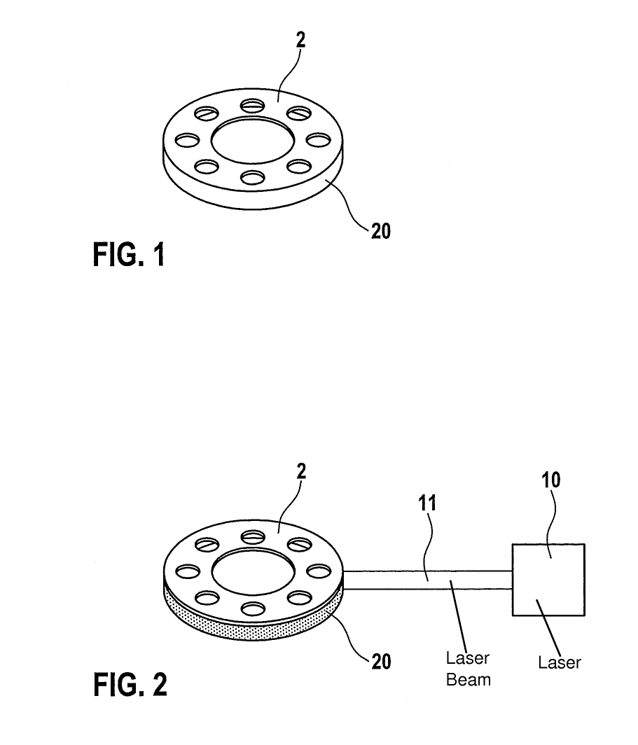

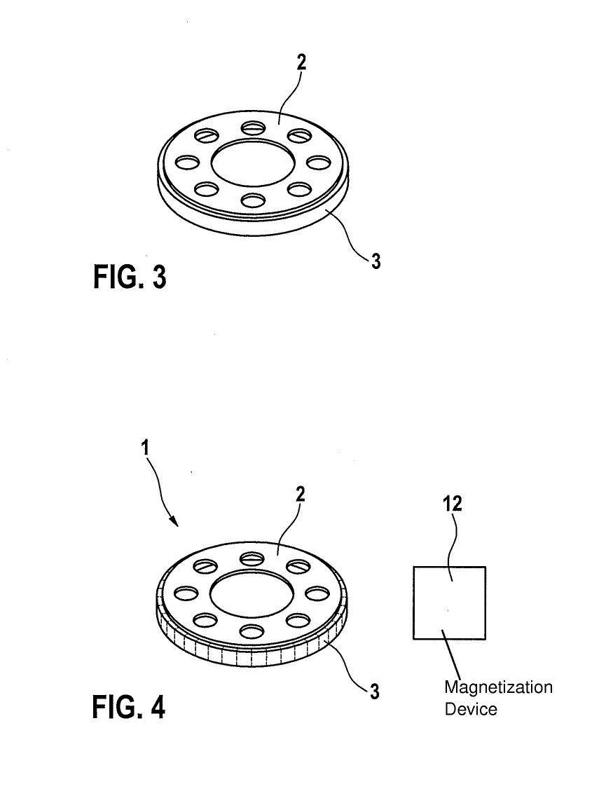

A method according to the present invention for manufacturing an encoder element and an encoder element 1 according to the present invention will be described hereafter in detail with reference to FIGS. 1 through 4.

Encoder element 1 according to the present invention is an encoder wheel in this exemplary embodiment, which includes a circular base body 2 and a magnetic layer 3. Magnetic layer 3 is situated for this purpose on an outer circumferential surface 20 of base body 2 with the aid of a direct, integral joint. Magnetic layer 3 is applied to outer circumferential surface 20 of base body 2 with the aid of a spraying process, in particular cold gas spraying or cold plasma spraying. Magnetic layer 3 may be manufactured from pure magnetic powder, or a magnetic powder in which the individual magnetic particles are situated in a plastic sheathing. Along the circumference, magnetic layer 3 has alternating polarizations to provide a multipole encoder wheel.

The method according to the present invention becomes apparent from FIGS. 1 through 4. In a first step, a circular base body 2 made of a metallic sheet metal material is provided in FIG. 1. Base body 2 has an outer circumferential surface 20 having a predefined width. In a next step shown in FIG. 2, outer circumferential surface 20 of base body 2 is machined with the aid of an ultrashort pulse laser 10 in such a way that nanostructures are created on outer circumferential surface 20. A laser beam 11 of ultrashort pulse laser 10 is exclusively directed to outer circumferential surface 20, the nanostructures being provided along the entire circumference of outer circumferential surface 20. Base body 20 is preferably rotated appropriately for this purpose.

In a next step, a magnetic or magnetizable powder is provided. This powdery material is then preferably sprayed onto the entire outer circumferential surface 20 of base body 2, so that a magnetic layer 3 is formed on outer circumferential surface 20. A direct, integral joint is thus formed between magnetic layer 3 and base body 2, the joint being in particular fluid-tight. As a result, no liquid is able to reach an area between base body 2 and magnetic layer 3.

Thereafter, in a last step, as indicated in FIG. 4, a plurality of magnetic poles are generated on magnetic layer 3 with the aid of a magnetization device 12. This provides encoder element 1 with a plurality of alternating magnetic norths and souths and/or gaps for position detection.

Due to the concept according to the present invention, it is thus possible to use a magnetic layer 3 made of magnetic or magnetizable powdery material, instead of rubber, as the base material for the multipole encoder element, this powdery material being considerably more cost-effective than rubber. It is likewise possible to spray on the magnetic or magnetizable powdery material without an injection molding tool, which is more cost-effective from a processing view. The application of the powdery material according to the present invention without tools may be carried out in a very controlled and easily automated manner, whereby the manufacturing costs may be significantly reduced. In addition, fast production changeovers, for example to encoder wheels for another customer, may be carried out. In particular due to the use of cold gas spraying or cold plasma spraying, a magnetic layer 3 may further be applied which has a minimum layer width and a minimum layer thickness. In addition, high precision during the manufacture may be achieved by using these two methods, so that no post-processing steps of the magnetic layer are required and thermally induced problems during the manufacture may be avoided. According to the present invention, it is thus possible to save several process steps as compared to the related art, which results in major cost advantages.

It shall further be noted that a large selection of plastic materials is possible when using a magnetic or magnetizable magnetic powder in which the individual magnetic particles are sheathed with a plastic material. The use of thermoplastics is particularly preferred, which may be appropriately selected for the particular application purpose. The use of thermoplastics in particular assures that the thermoplastics are concentrated on the outer surface of the magnetic layer after the layer has been applied, so that the thermoplastic material forms an additional, outer anti-corrosion layer.

Moreover, the material for base body 2 may be selected as a function of the application purpose; for example stainless steel, aluminum, cold rolled strip or sheet metal, and even plastic base bodies could be implemented with the plasma method. In addition or as an alternative, magnetic layer 3 could also be applied to an end face of base body 2.

What is claimed is:

1. A method for manufacturing an encoder element having a base body and a magnetic layer situated on an outer circumference of the base body, comprising:
providing the base body;
providing one of a magnetic and magnetizable powdery material;
directly applying the powdery material to one of the outer circumference and an end face of the base body to generate the magnetic layer in such a way that an integral, direct joint is created between the base body and the magnetic layer; and
magnetizing the applied magnetic layer.

2. The method as recited in claim 1, wherein the powdery material is applied without tools with the aid of a jet.

3. The method as recited in claim 1, further comprising:
generating a nanostructure on the base body prior to the step of applying the powdery material.

4. The method as recited in claim 3, wherein the nanostructure is generated one of:
with the aid of an ultrashort pulse laser, and
with the aid of an etching method.

5. The method as recited in claim 1, wherein the magnetic layer is applied in a thickness of less than or equal to 1 mm.

6. The method as recited in claim 1, wherein the magnetic layer is applied in a thickness of less than or equal to 0.8 mm.

7. The method as recited in claim 1, wherein the powdery material has a particle diameter of smaller than or equal to 40 μm.

8. The method as recited in claim 2, wherein the magnetic layer is applied with the aid of a cold gas spraying method.

9. The method as recited in claim 2, wherein the magnetic layer is applied with the aid of a cold active plasma jet.

10. The method as recited in claim 1, wherein the powdery material includes one of:
a pure magnetic powder, and
a magnetic powder in which the individual magnetic particles are one of partially and completely sheathed with a plastic material.

11. An encoder element, comprising:
a base body; and
a magnetic layer situated on the base body and applied according to a method for manufacturing the encoder element , comprising:
providing the base body;
providing one of a magnetic and magnetizable powdery material;
directly applying the powdery material to one of an outer circumference and an end face of the base body to generate the magnetic layer in such a way that an integral, direct joint is created between the base body and the magnetic layer; and
magnetizing the applied magnetic layer.
